(19) United States
(12) Patent Application Publication
(10) Pub. No.: US 2007/0162594 A1
(43) Pub. Date: Jul. 12, 2007

(54) Controlled disconnection of a network device

(75) Inventors: Brian L. Henry, Kirkland, WA (US); Jeffrey B. Kinsey, Redmond, WA (US); Pankaj Garg, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/330,645

(22) Filed: Jan. 12, 2006

(51) Int. Cl. G06F 15/173

(52) U.S. Cl. 709/224

(57) ABSTRACT

Methods, computer-readable media and systems for preparing for the disconnection of a device from a network. In the method, a pending disconnection of a network device is detected and a message indicative of the pending disconnection is generated. The message is sent to at least one component of the network and the disconnection of the device is paused.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2005, Microsoft Corp.

### BACKGROUND

In a typical networked computer environment a planned or unplanned outage may occur to a device within the network. In a planned outage, a device that is consuming or providing a network resource has the opportunity to remove itself from the network in a manner that does not adversely affect other devices in the network.

For example, if a computer is consuming a database under an elevated lock, other computers are prevented from accessing the database at the same time. In a planned outage, the computer consuming the database releases its lock before being shut down. In such a manner, other computers are able to then immediately access the database. In an unplanned outage, the computer consuming the database does not release its lock before being shut down. The database must then determine, typically after a predetermined time or number of failed attempts to reach the computer, whether the computer is still available. At this point, the database may revoke the lock from the computer and then give the lock to some other device that is waiting to access the database. Unfortunately, the time spent between the unplanned outage and the re-granting of the lock to another computer is wasted because no devices are able to access the database during that time.

This situation may occur in any number of scenarios. For example, a computer could be part of a load balancing group that provides web services to clients, where each computer in the group is configured to handle predetermined clients. In a planned outage, the computer being removed from the group distributes its clients to the other computers in the group such that no clients are left without a server. In an unplanned outage, the clients of the removed computer are left without a server (i.e., they experience an outage) unless or until the load balancing group recognizes the removal of the computer, at which time the clients are redistributed. Similar situations may occur when a computer is participating in a Dynamic Host Configuration Protocol (DHCP) allocation of Internet Protocol (IP) addresses. An unplanned outage in these situations causes the addresses to be rendered unavailable for a certain amount of time.

In each of the unplanned outage situations discussed above, the fault tolerance of the network, and any devices located therein, are relied upon to rectify the situation. Unfortunately, such a mechanism takes an amount of time during which a network resource is rendered unavailable, which is highly undesirable. Conventionally, networking configurations lack facilities that enable a network device to remove itself from the network in the event of a power-down inside a physical or virtual machine. In the case of a virtual machine, a save operation is particularly problematic because a save operation is typically a planned event. Conventional virtual machine environments, however, treat virtual machine saves as an unplanned event, which involves an unplanned event's undesirable characteristics.

### SUMMARY

In view of the foregoing shortcomings and drawbacks, methods, computer-readable media and systems are provided for preparing for the disconnection of a device from a network. For example, in the method, a pending disconnection of a network device is detected and a message indicative of the pending disconnection is generated. The message is sent to at least one component of the network and the disconnection of the device is paused.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following detailed description, is better understood when read in conjunction with the appended drawings. For the purpose of illustrating various embodiments, there is shown in the drawings example embodiments; however, embodiments are not limited to the specific methods and instrumentalities disclosed. In the drawings:

FIG. 1 is a diagram illustrating an example computing environment in which aspects of an embodiment may be implemented;

FIG. 2A is a diagram illustrating an example logical layering of a hardware and software architecture in a virtualized environment in which aspects of an embodiment may be implemented;

FIG. 2B is a diagram illustrating an example network driver model in which aspects of an embodiment may be implemented;

FIG. 3 is a diagram functionally illustrating an example message according to an embodiment;

FIGS. 4A-B are flowcharts illustrating example methods according to one embodiment; and

FIG. 5 is an example Uniform Modeling Language (UML) diagram that describes a virtual machine life cycle according to one embodiment.

### DETAILED DESCRIPTION

The subject matter of the various embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Example Computing Environment

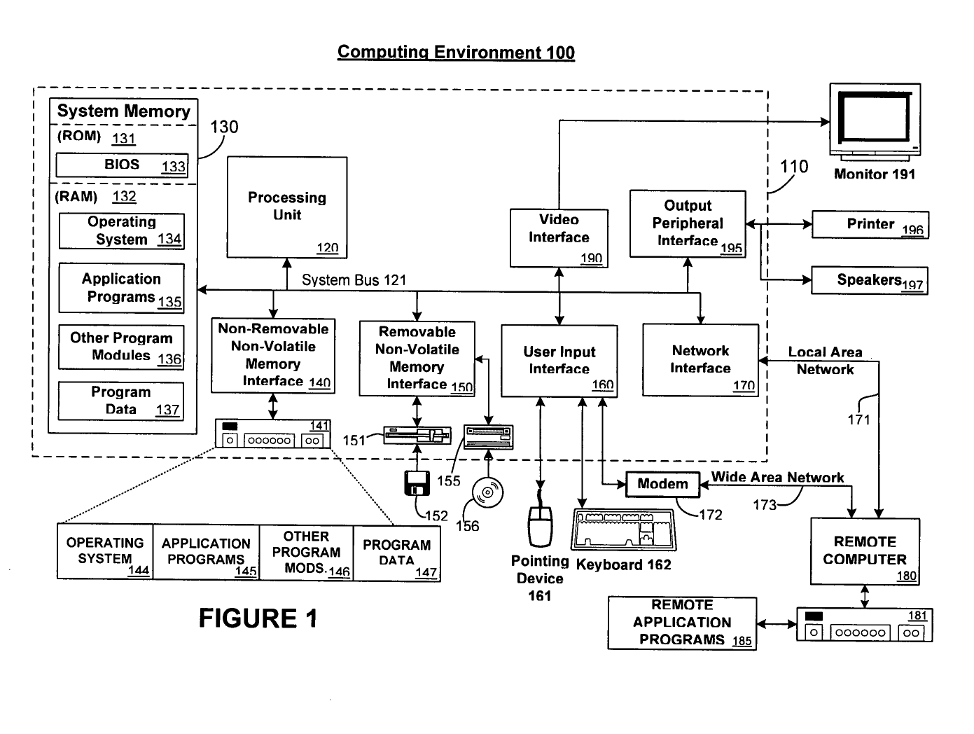

FIG. 1 illustrates an example of a suitable computing system environment 100 in which an embodiment may be implemented. The computing system environment 100 is only one example of a suitable computing environment and is not intended to suggest any limitation as to the scope of use or functionality of various embodiments. Neither should the computing environment 100 be interpreted as having any dependency or requirement relating to any one or combination of components illustrated in the example operating environment 100.

Embodiments may be operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments may be described in the general context of computer-executable instructions, such as program modules, being executed by a computer. Generally, program modules include routines, programs, objects, components, data structures, etc., that perform particular tasks or implement particular abstract data types. Typically the functionality of the program modules may be combined or distributed as desired in various embodiments. Embodiments may also be practiced in distributed computing environments where tasks are performed by remote processing devices that are linked through a communications network. In a distributed computing environment, program modules may be located in both local and remote computer storage media including memory storage devices.

With reference to FIG. 1, an example system for implementing various embodiments includes a general purpose computing device in the form of a computer 110. Components of computer 110 may include, but are not limited to, a processing unit 120, a system memory 130 and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read-only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146 and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are example and other means of establishing a communications link between the computers may be used.

Virtual Machines

An embodiment may be implemented in connection with one or more virtual machines. It will be appreciated that an embodiment may be implemented in connection with any type of network device that is operating in any type of computing network, and that a virtual machine is used herein as a representative example of an embodiment. Virtualization is a technology that allows a user to concurrently run two or more operating systems on a computer. Virtualization prevents complicated multi-boot configurations in environments where multiple operating systems are used. Such complicated multi-boot configurations sometimes result from incompatible legacy applications or are used as a safeguard during migration. A user may install multiple guest operating systems in virtual machines. Virtualization technology emulates a physical computer (as a “virtual machine”) such that an application a user may install in such a virtual machine cannot distinguish the virtual machine from a physical computer.

Each virtual machine acts as a standalone computer, and may have its own sound, video, hard disk and network cards, as well as its own processor. Each virtual machine may also run its own operating system. A users can install and run most operating systems in a virtual machine. Any application that a user properly installs in a virtual machine works normally, including business, education, entertainment, Internet and other programs. Depending on the virtualization environment, devices that a user may connect to a physical computer, such as printers, modems, CD-ROM drives, USB devices and so on, may work normally in a virtual machine. Changes that a user may make in a virtual machine do not affect the physical computer in which the virtual machine is installed.

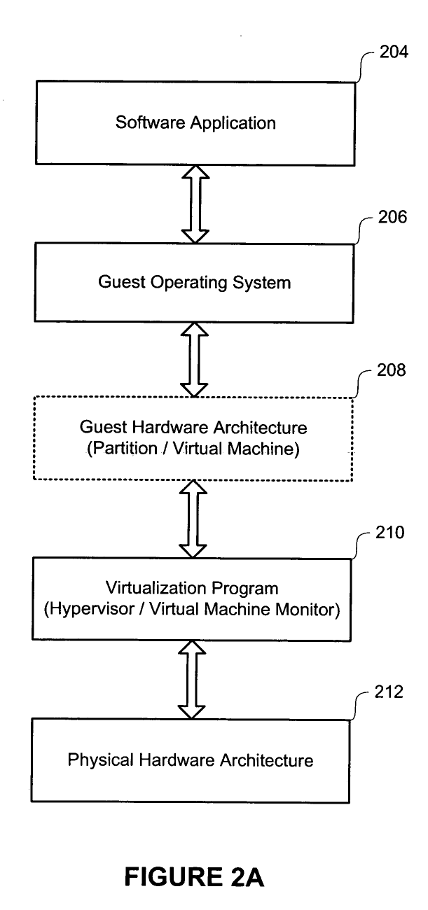

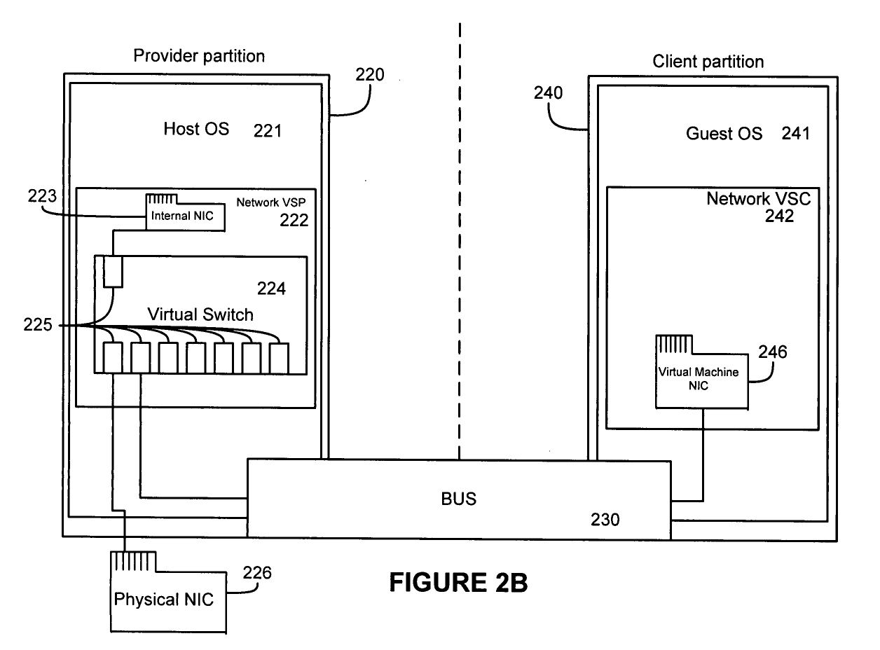

FIG. 2A is a diagram representing an example logical layering of the hardware and software architecture in a virtualized environment in a computer system. In FIG. 2A, virtualization program 210 runs directly or indirectly on physical hardware architecture 212. Virtualization program 210 may be, for example, a virtual machine monitor that runs alongside a host operating system or a host operating system with a hypervisor component that performs the virtualization. Virtualization program 210 virtualizes guest hardware architecture 208 (shown as dashed lines in FIG. 2A to illustrate that this component is a partition or a “virtual machine”), that is, hardware that does not actually exist but is instead virtualized by virtualizing program 210. Guest operating system 206 executes on guest hardware architecture 208, and software application 204 runs on guest operating system 206. In the example virtualized operating environment of FIG. 2A, software application 204 can run in a computer system even if software application 204 is designed to run on an operating system that is generally incompatible with a host operating system or hardware architecture 212.

In one embodiment, the virtualized environment may include a “partition bus” (not shown), which is a software model of a hardware bus. The partition bus allows for formalization of an inter-partition data transfer mechanism and allows for the transfer of, for example, status messages between virtual machines in the environment. Details relating to partition buses may be found in commonly-assigned U.S. patent application Ser. No. 11/128,647, filed May 12, 2005 and titled “Partition Bus,” the disclosure of which is herein incorporated by reference in its entirety. It will be appreciated that the example virtualized environment discussed above, as well as the presence of a partition bus, are not required by an embodiment. Rather, various embodiments may be employed by and in any type of computer environment, whether physical or virtual in nature. In addition, reference made herein to a “network” include any type of computing environment, whether physical or virtual in nature. Thus, the word “network” refers to any operatively-connected collection of components, devices, software applications, computers, virtual machines, partitions, and the like, whether embodied in one or more physical or virtual computing devices.

FIG. 2B illustrates an example network driver model in which aspects of an embodiment may be implemented. The model is divided into provider partition 220 and client partition 240. It will be appreciated that any number of client partitions 240 may be present in the model, and that only one such client partition 240 is illustrated in FIG. 2B for clarity. Provider partition 220 includes host operating system 221, which in turn includes network Virtualization Service Provider (VSP) 222. VSP 222 includes switch 224 for switching between processes, as well as software and hardware components. VSP 222 may be any software that provides virtualization services (i.e., virtualizes hardware) to a client such as client partition 240. Such processes and components may be accessed by switch 224 by way of ports 225. For example, one of ports 225 may access physical Network Interface Card (NIC) 226 for interfacing with a hardware component.

Client partition 240 includes guest operating system 241. It will be appreciated that guest operating system 241 may be the same or a different operating system than host operating system 221. Guest operating system 241 includes network Virtualization Service Client (VSC) 242, which includes virtual machine NIC 246. VSC 242 may be any software or hardware that enables a virtual machine to interface with its physical host, which may be by way of provider partition 220. NIC 246 interfaces with a port 225 of virtual switch 224 by way of bus 230, which may be a partition bus as discussed above.

Example Embodiments

As noted above, devices in a networked computing environment may be disconnected from the network for a variety of situations. In some situations, the impending disconnection may be known in advance. An embodiment provides a mechanism by which devices that will be affected by the disconnection of another device can take an action to prepare for the disconnection. Such actions may involve, for example, releasing or reassigning network resources, saving information, etc.

For clarity, the disclosure herein largely focuses on an embodiment that may be implemented in a virtualized computing environment. As was noted above, however, embodiments are not so limited, as an embodiment may be used in connection with any type of computing environment. In addition, it will be appreciated that an implementation of an embodiment may involve the modification of currently-existing hardware or software to carry out the methods disclosed herein, or may require the creation of new hardware or software. Details relating to such creation or modification within a physical or virtualized computing environment is assumed to be known by one skilled in the art, and therefore details relating to such matters are omitted for clarity.

As noted above, some events that involve the disconnection of a device from a network can be known in advance. A “save” operation of a virtual machine is an example of one such event. The save operation occurs outside the context of the operating system (OS)—in other words, the OS does not “know” that the save operation is occurring. Thus, to the OS, and the network in general, when the save operation takes place the virtual machine is disconnected from the network. However, a virtualization program (such as, for example, virtualization program 210 discussed above in connection with FIG. 2A) may be aware of or has initiated the save operation.

Therefore, one embodiment provides that such virtual machine hardware or software recognizes an event that will cause a disconnection from the network. For example, when a virtual machine is about to initiate or carry out a save operation, the virtual machine administrator or the like may recognize that the save operation may cause a disconnection from the network. Upon recognizing that a pending operation is going to cause a network disconnection, a message is generated that informs the network, or affected components (e.g., hardware or software) within the network, that the virtual machine is about to be disconnected.

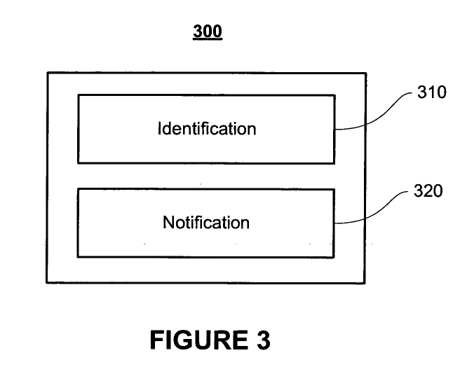

An example message 300 is illustrated in FIG. 3. Message 300 may be any type of communication that conveys the information contained in fields 310 and 320. For example, message 300 may be configured as a type of control message that can be sent by way of the aforementioned partition bus. Alternatively, message 300 may be a multicast packet. Any type or form of message 300 may be employed in connection with an embodiment. Message 300 includes identification 310 and notification 320. Identification 310 may be any information that conveys the identity of the virtual machine to be disconnected. Alternatively, identification 310 may identify the components that will be affected by the disconnection of the virtual machine. Notification 320 may be any information that indicates that the virtual machine is going to be disconnected. Notification 320 may simply provide an indication that disconnection will occur, or may provide more detailed information such as, for example, the specific type of operation that the virtual machine is about to undergo. Alternatively, notification 320 may simply include an instruction to a receiving component to prepare for a disconnection. In an embodiment that employs a partition bus, message 300 may take the form of a status control message such as, for example: NDIS_STATUS_MEDLA_PREPARE_FOR_DISCONNECT, or the like, as will be discussed below.

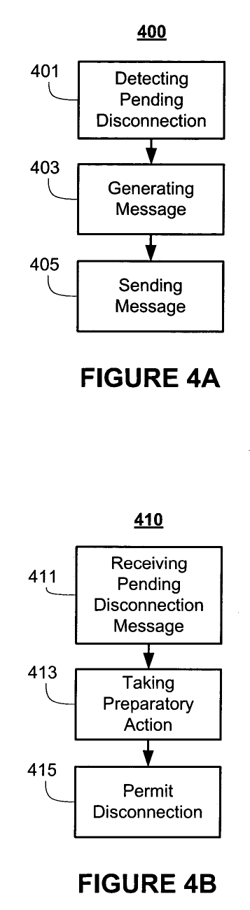

FIG. 4A illustrates an example method 400 of creating a message to indicate the impending disconnection of a network device such as, for example, a virtual machine. At step 401, the pending disconnection of a device is detected. For example, and as noted above, a virtual machine save will typically remove the virtual machine from its network. The start of a virtual machine save may be initiated by an administrator of the virtual machine system. The administrator contacts a network VSP (e.g., VSP 222 discussed above in connection with FIG. 2B), or the like, to notify the VSP of the impending save operation. Thus, in such an embodiment, the VSP would recognize that the save operation that is about to be performed by the administrator will disconnect the machine from the network. Such recognition may be enabled by, for example, a memory or the like that identifies operations that result in the disconnection of a device on which the operation is performed. At step 403, a message—such as message 300 discussed above in connection with FIG. 3—is generated. The VSP may generate such a message. As noted above, in one embodiment the message may be a type of status control message to be conveyed by a partition bus, or may be a type of multicast packet. Other embodiments may use other types of messages.

At step 405, the message is sent to one or more components (e.g., software, network stacks, computers, partitions, virtual machines, etc.) in the network. In an embodiment that employs a multicast packet as the message, switches or hubs within the network may broadcast the multicast packet to all devices, and then a host or the like may decide whether the message is applicable. Alternatively, a switch or hub can send the packet to specified targets. In either case, an embodiment may define a multicast address to state that a virtual machine that is connected to the entity that receives the address is about to be disconnected. In an embodiment in which a partition bus is available, the network VSP may send a message indicating the pending disconnection of its device to the network VSC (e.g., VSC 242 as discussed above in connection with FIG. 2B) by way of the bus, for example.

It will be appreciated that in one embodiment the message should be sent to all layers of the network to ensure that all network components (e.g., hardware, applications, services, etc.) that might be affected by the disconnection receive the message. For example, in a virtualized computing environment, the message should be sent to all layers of the guest operating system's networking stack. Because virtual machine networking systems generally provide the lowest layer in the guest operating system's network stack, one embodiment starts the propagation of the message at this lowest level and allows the message to propagate up through the stack. Alternatively, an embodiment may start the propagation of the message at another, higher level in the stack.

In addition, an embodiment may provide that the disconnection of the virtual machine may be paused so that, as will be discussed below in connection with FIG. 4B, other components, network stacks and the like will have an opportunity to prepare for the disconnection.

FIG. 4B illustrates example method 410. In method 410, at step 411, a message indicating the pending disconnection of a virtual machine is received. As noted above, the message may be received by hubs or routers (in an embodiment using a multicast packet), by VSC that passes the message to a network stack (in an embodiment using a partition bus), or the like.

At step 413, one or more actions preparatory to the disconnection are taken by a network component. It will be appreciated that the exact steps taken to prepare for the disconnection of the virtual machine may vary depending on, for example, the type of network component making the preparations, the type of virtual machine being disconnected, and the like. For example, in an operating system, a device is typically controlled by a driver that ties into a driver stack. In some operating systems, such as the WINDOWS® operating system by Microsoft Corporation of Redmond, Wash., the driver is called a Network Driver Interface Specification (NDIS) miniport. A network VSC is an example of an NDIS miniport. Communication with the NDIS miniport is enabled by a series of interfaces that provide a means by which messages may be sent to the device stack. One such interface is used to indicate a generic status to higher-level drivers in the driver stack. Some existing systems have an NDIS_STATUS_MEDIA_DISCONNECT status message that indicates a disconnection of a device has already occurred. As may be appreciated, this type of message is sent after the disconnection, and therefore does not provide an opportunity for other network components to prepare for the disconnection.

Instead, and according to one embodiment, the network VSC may respond to the message received in step 411 by issuing a new NDIS status using a status message that indicates an imminent disconnection such as, for example: NDIS_STATUS_MEDIA_PREPARE_FOR_DISCONNECT. This status message could be propagated to upper layers of the stack by the network VSC calling an NdisMIndicateStatus function, for example. As a result, the software entities in the stack that are located in a higher layer than the NDIS miniport have an opportunity close connections to the device that is about to be disconnected, reallocate resources, and the like. For example, closing a TCP/IP connection requires participation of both connected entities. Thus, the advance warning of the disconnection could allow the soon-to-be-disconnected virtual machine and a component to which it is connected by way of a TCP/IP connection to break the connection without errors or unduly tying up network resources.

At step 415, disconnection of the device, such as a virtual machine, is permitted. It will be appreciated that in one embodiment, the disconnection may be automatic and no further action is required of any network components. In another embodiment, and as noted above in connection with FIG. 4A, the disconnection of the virtual machine may be postponed while any preparatory action is performed in connection with step 413 above. In such an embodiment, therefore, a mechanism may need to be employed to inform the network that preparations for disconnection of the virtual machine have taken place and that the disconnection may proceed.

For example, the network stack of the guest operating system may notify the network VSC that the disconnection preparations have been completed. This notification can either be a new function entry point to the NDIS miniport interface, a new Object Identifier (OID), a custom IOCTL, or the like. In any event, the network VSC may respond to the notification by sending a message back to the VSP indicating that the disconnection may continue. Alternatively, a predetermined amount of time may be allowed to elapse after the message discussed above in connection with step 405 of FIG. 4A is sent. This amount of time may, in an embodiment, be predetermined to allow sufficient time for the network stack or the like to process the message. Once the predetermined amount of time has completed, the network VSP may allow the disconnection to occur. It will be appreciated that various combinations of these two or other mechanisms may be used according to an embodiment.

It will be appreciated that an embodiment therefore provides a mechanism for enabling network resources to prepare for the disconnection of a network device. The following non-exhaustive list of examples illustrate some of the situations that may be provided for according to an embodiment.

For example, a computer that is to be shut down may be participating in a DHCP allocation of IP addresses and consuming one or more addresses—depending on the number of physical and virtual network cards, for example—for the duration of its uptime. Using the mechanism provided by an embodiment, for example, the computer can release its DHCP leases and free the resources for other computers in the DHCP administrative domain. Such a situation may also reduce the number of IP addresses that need to be allocated.

As another example, a computer could be part of a load balancing group that provides web services to clients, where each computer in the group is configured to handle predetermined clients. Using the mechanism provided by an embodiment, the computer being removed from the group distributes its clients to the other computers in the group such that no clients are left without a server.

As yet another example, a computer that is consuming a database under an elevated lock may, using the mechanism of an embodiment, release its lock before being shut down. In such a manner, other computers are able to then immediately access the database.

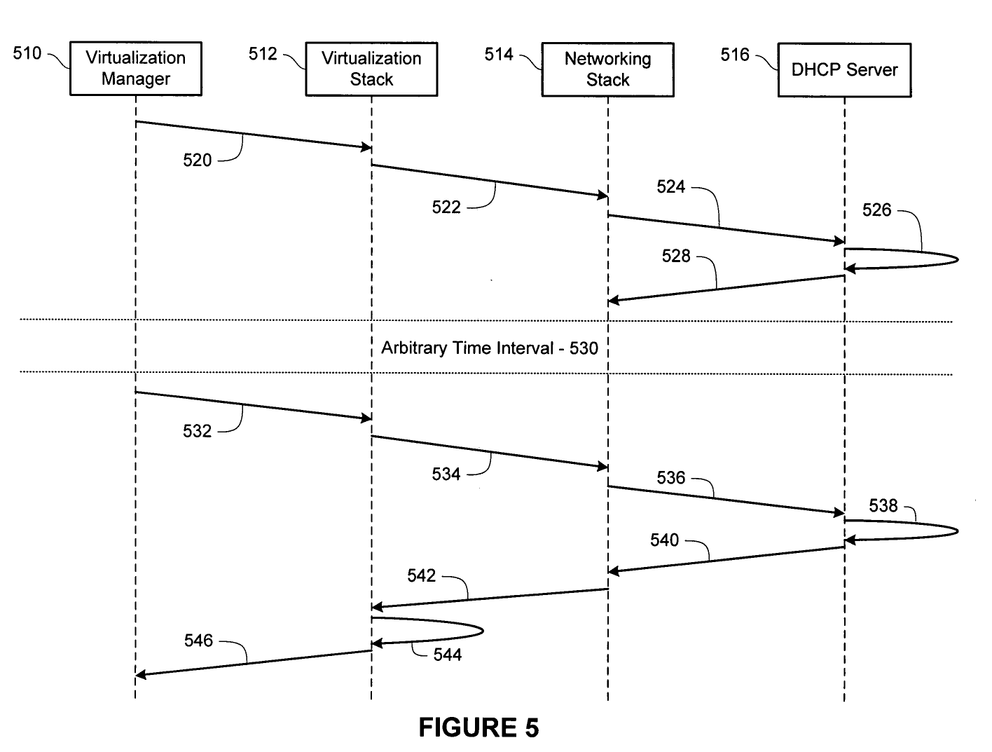

To further explain and illustrate an embodiment, FIG. 5 is an example Uniform Modeling Language (UML) diagram that describes an example virtual machine life cycle from creation to saving (i.e., disconnection from the network). It will be appreciated that FIG. 5 does not represent all possible virtual machine lifecycles and further does not represent all possible lifecycles of every type of network device, whether physical or virtual in nature, that may be used in connection with an embodiment.

Virtualization manager 510 may be any combination of software components that manage a virtual machine. Virtualization stack 512 comprises different components of the virtual machine that represent virtual hardware. For example, such components may emulate a motherboard, I/O device, memory or other hardware component for use by a virtual device. Networking stack 514 comprises components that enable networking. DHCP server 516 may be, for example, a conventional DHCP server.

Arrows 520-546 represent example steps that may be taken by network components 510-516 during an example lifecycle of a virtual machine. Arrow 520 represents the creation of a virtual machine. Such creation may be at the direction of a user, application or the like. As part of the creation of the virtual machine, virtualization stack 512 may, for example, allocate system memory for the virtual machine, set up an appropriate processor state for the virtual machine, etc. Arrow 522 represents the creation of a network stack interface. Any or all of steps necessary to create a network stack interface may be performed by a host operating system, hypervisor or the like. The network stack, which is a layered set of software that sends and receives messages over the network, enables the virtual machine to communicate with other devices on the network.

Arrows 524-528 represent any manner of providing an address for virtual machine to enable the virtual machine to communicate with devices on the network, and may be conventional. For example, arrow 524 represents the requesting of an IP address lease from DHCP server 516, arrow 526 represents the assignment of a DHCP address from DHCP server 516 and arrow 528 represents the grant of a DHCP address from DHCP server 516, which is returned to networking stack 514.

After arbitrary time interval 530—which may be, as the name implies, a time interval of any length, during which the virtual machine may communicate with the network—the virtual machine may be disconnected from the network. Such a disconnection may be requested by a user, application or the like. As noted above, a save operation of the virtual machine may result in the disconnection of the virtual machine from the network. Thus, arrow 532 represents an indication that the virtual machine is to be saved. As was also noted above, a virtual machine save is a planned operation.

Arrow 534 represents a message indicating that the virtual machine is about to be disconnected. The message may be as discussed above in connection with message 300 of FIG. 3, for example. The message may be initiated by virtual networking hardware on virtualization stack 512 and sent to networking stack 516, and may indicate to networking stack 516 that the virtual machine is to be disconnected.

Arrow 536 represents a message from networking stack 514 to DHCP server 516 that the lease is to be relinquished. Arrow 538 represents the return of the IP address used by the virtual machine to the pool of available IP addresses by DHCP server 516, and arrow 540 represents a DCHP server 516 acknowledgement of the return of the IP address to the IP address pool.

Arrow 542 represents a message from networking stack 514 to virtualization stack 512 that the virtual machine may be “torn down” (i.e., disconnected from the network). Thus, arrow 544 represents the tear down (i.e., saving and/or disconnecting) of the virtual machine. The tearing down of the virtual machine may entail the removal of the instance of the virtual machine from its managed space. In an embodiment, virtualization stack 512 is also torn down. In some embodiments, networking stack 514 is also torn down, while in other embodiments networking stack 514 remains present in the network after the virtual machine has been disconnected. Finally, arrow 546 represents the completion of the removal of the virtual device from the network.

While the various embodiments have been described in connection with the preferred embodiments of the various figures, it is to be understood that other similar embodiments may be used or modifications and additions may be made to the described embodiment for performing the same function of the various embodiments without deviating therefrom. Therefore, the embodiments should not be limited to any single embodiment, but rather should be construed in breadth and scope in accordance with the appended claims.

What is claimed:

1. A computer-readable medium having computer-readable instructions, said computer-readable instructions comprising instructions for:
detecting that a disconnection of a device that is operating within a computer network is pending;
generating a message indicative of the pending disconnection; and
sending the message to at least one component of the network.

2. The computer-readable medium of claim 1, further comprising computer readable instructions for pausing the disconnection of the device.

3. The computer-readable medium of claim 2, further comprising resuming the disconnection of the device after a predetermined time period has elapsed.

4. The computer-readable medium of claim 2, further comprising computer readable instructions for resuming the disconnection of the device.

5. The computer-readable medium of claim 1, wherein the device to be disconnected receives the message.

6. The computer-readable medium of claim 1, further comprising computer readable instructions for receiving the message and performing one of: reallocating a resource being consumed by the device and closing a connection to the device.

7. The computer-readable medium of claim 1, wherein the at least one component of the network is a network stack having a plurality of layers, and wherein the network stack receives the message at a first layer of the stack and propagates the message to a second, higher layer of the stack.

8. The computer-readable medium of claim 1, wherein the message comprises an identification of the device to be disconnected and a notification of the disconnection.

9. The computer-readable medium of claim 1, wherein the message is a multicast message.

10. The computer-readable medium of claim 1, wherein the device is a virtual machine and the computer network is a virtualized computing environment.

11. The computer-readable medium of claim 10, wherein the message is a status control message and wherein said sending is by way of a partition bus.

12. A system for preparing for the disconnection of a virtual machine within a virtualized computing environment, comprising:
a first component that detects a pending disconnection of the virtual machine and sends a first message indicative of the pending disconnection; and
a second component that receives the first message, and sends a second message to a first layer of a network stack, wherein the network stack propagates the second message to a second layer, and wherein the second message is adapted to prompt at least one component of the virtualized computing environment to prepare for the pending disconnection of the virtual machine.

13. The system of claim 12, wherein the virtual machine to be disconnected receives the second message.

14. The system of claim 12, further comprising a partition bus that enables operative communication between the first component and the second component.

15. The system of claim 12, wherein, upon the at least one component of the virtualized computing environment completing preparations for the pending disconnection of the virtual machine, the second component sends a third message to the first component indicating the completion of preparations and wherein the first component resumes the disconnection of the virtual machine.

16. The system of claim 15, wherein the first component is a network VSP and the second component is a Network Driver Interface Specification (NDIS) miniport, and wherein the third message is one of: a function entry point to the NDIS miniport, a new Object Identifier (OID) and a custom IOCTL.

17. A method comprising:
detecting that a disconnection of a device that is operating within a computer network is pending;
generating a message indicative of the pending disconnection; and
sending the message to at least one component of the network.

18. The method of claim 17, further comprising:
pausing the disconnection of the device; and
resuming the disconnection of the device after a predetermined time period has elapsed.

19. The method of claim 17, wherein the device to be disconnected receives the message.

20. The method of claim 17, wherein the at least one component of the network is a network stack having a plurality of layers, and wherein the network stack receives the message at a first layer of the stack and propagates the message to a second, higher layer of the stack.
